(19) United States
(12) Patent Application Publication
(10) Pub. No.: US 2020/0132012 A1
(43) Pub. Date: Apr. 30, 2020

(54) SOLENOID VALVE DRIVE CONTROL CIRCUIT, SOLENOID VALVE DRIVE DEVICE, AND FUEL INJECTION APPARATUS

(71) Applicants: Panasonic Intellectual Property Management Co., Ltd., Osaka (JP); Kelhin Corporation, Tokyo (JP)

(72) Inventors: Keisuke KURODA, Osaka (JP); Makoto KAWAJIRI, Kyoto (JP); Ken MARUYAMA, Osaka (JP); Takashi RYU, Kyoto (JP); Atsushi OGAWA, Tochigi (JP); Motoaki KATO, Tochigi (JP); Kengo NOMURA, Tochigi (JP)

(21) Appl. No.: 16/726,080

(22) Filed: Dec. 23, 2019

Related U.S. Application Data
(63) Continuation of application No. PCT/JP2018/020432, filed on May 29, 2018.

(30) Foreign Application Priority Data
Jun. 29, 2017 (JP) 2017-126835

(51) Int. Cl. F02D 41/30; F02M 51/06; F02D 45/00

(52) U.S. Cl. CPC F02D 41/3005; F02D 2041/2055; F02D 45/00; F02M 51/061

(57) ABSTRACT

A solenoid valve drive control circuit includes: a timing generator circuit that outputs a timing signal for controlling a driver circuit, in accordance with a solenoid valve opening and closing instruction signal; and a valve closing detector circuit that detects a valve closing timing after the timing generator circuit outputs the timing signal for instructing a solenoid valve to close, by monitoring a solenoid valve outflow terminal voltage in the solenoid valve as a signal voltage. The valve closing detector circuit includes a measurement circuit that (i) detects each timing signal reaching a threshold voltage sequentially outputted from a threshold voltage selector circuit, and (ii) outputs a signal indicating the valve closing timing when a change in a measurement value that is obtained through measurement of a time interval of each timing satisfies a predetermined condition.

### CROSS REFERENCE TO RELATED APPLICATIONS

This application is a U.S. continuation application of PCT International Patent Application Number PCT/JP2018/020432 filed on May 29, 2018, claiming the benefit of priority of Japanese Patent Application Number 2017-126835 filed on Jun. 29, 2017, the entire contents of which are hereby incorporated by reference.

### BACKGROUND

### 1. Technical Field

The present disclosure relates to (i) a solenoid valve drive device including a solenoid valve drive control circuit, a solenoid valve drive control circuit, and a driver circuit that control a driver circuit including a switching element that causes a current to flow to a solenoid valve, and (ii) a fuel control apparatus including the solenoid valve drive device and the solenoid valve.

### 2. Description of the Related Art

Regarding a solenoid valve drive device for injecting fuel into an engine of a vehicle and the like, there is a technique that correctly detects a solenoid valve opening and closing timing and controls a desired fuel injection amount by correcting an energization period of the solenoid valve in order to improve fuel efficiency (see, for example, Japanese Unexamined Patent Application Publication No. 2014-31731).

Japanese Unexamined Patent Application Publication No. 2014-31731 discloses a technique that detects (i) each timing of a coil current of the solenoid valve dropping down to a comparison threshold value and (ii) a valve closing timing based on each timing.

However, Japanese Unexamined Patent Application Publication No. 2014-31731 has the problem that when detecting the valve closing timing, a delay time from when a driving period ends to when the solenoid valve closes becomes longer, respectively increasing the fuel injection amount in order to gradually reduce the coil current of the solenoid valve. When controlling minute injection amounts, there is the risk of such an increase in the fuel injection amount impinging engine combustion and emission.

The present disclosure aims to solve this conventional problem by providing a solenoid valve drive control circuit, solenoid valve drive device, and fuel injection apparatus that are capable of shortening the delay time from when the driving period ends to when the solenoid valve closes and correctly detecting the valve closing timing.

### SUMMARY

In order to achieve the above objective, a solenoid valve drive control circuit according to an aspect of the present disclosure that controls a driver circuit including a switching element that causes a current to flow to a solenoid valve includes: a timing generator circuit that generates and outputs a timing signal for causing the switching element to be turned on and off, in accordance with a control signal inputted from outside for instructing the solenoid valve to open and close; and a valve closing detector circuit that detects a valve closing timing after the timing generator circuit outputs the timing signal for instructing the solenoid valve to close, by monitoring a signal voltage that is determined depending on a voltage in at least one of two terminals included in the solenoid valve for causing the current to flow, the valve closing timing being a timing at which the solenoid valve closes. The valve closing detector circuit includes: a threshold voltage selector circuit that sequentially selects and outputs a threshold voltage from a plurality of threshold voltages; a comparator that compares the threshold voltage sequentially outputted from the threshold voltage selector circuit with the signal voltage; and a measurement circuit that (i) detects, based on an output from the comparator, each timing of the signal voltage reaching the threshold voltage sequentially outputted from the threshold voltage selector circuit, and (ii) outputs a signal indicating the valve closing timing when a change in a measurement value that is obtained through measurement of a time interval of each timing satisfies a predetermined condition.

In order to achieve the above objective, a solenoid valve drive device according to an aspect of the present disclosure includes: a driver circuit including a switching element that causes a current to flow to a solenoid valve; and the above solenoid valve drive control circuit that controls the driver circuit.

In order to achieve the above objective, a fuel injection apparatus according to an aspect of the present disclosure includes a solenoid valve for injecting fuel into an engine of transportation equipment; and the above solenoid valve drive device that performs drive control of the solenoid valve.

The present disclosure makes it possible to implement the solenoid valve drive control circuit, solenoid valve drive device, and fuel injection apparatus that are capable of shortening the delay time from when the driving period ends to when the solenoid valve closes and correctly detecting the valve closing timing.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a circuit diagram showing a configuration of a fuel injection apparatus according to Embodiment 1;

FIG. 2 is a circuit block diagram showing a detailed configuration of a measurement circuit shown in FIG. 1;

FIG. 3 is a timing diagram showing an operation of a solenoid valve drive device according to Embodiment 1;

FIG. 4 is a timing diagram showing an operation of a valve closing detector circuit according to Embodiment 1;

FIG. 5 is a flowchart showing a detection process of a valve closing timing performed by the measurement circuit according to Embodiment 1;

FIG. 6 is a circuit diagram showing a configuration of a fuel injection apparatus according to Embodiment 2;

FIG. 7 is a timing diagram showing an operation of a solenoid valve drive device according to Embodiment 2; and

FIG. 8 is a timing diagram showing an operation of a valve closing detector circuit according to Embodiment 2.

### DETAILED DESCRIPTION OF THE EMBODIMENTS

Hereinafter, embodiments of the present disclosure will be described in detail with reference to the drawings. Note that each of the embodiments described below shows a specific example in the present disclosure. Numerical values, shapes, circuits, circuit components, connection of the circuits, process orders, signal waveforms, and the like are mere examples and are not intended to limit the present disclosure. Components in the following embodiments not mentioned in any of the independent claims that define the broadest concepts are described as optional elements.

### Embodiment 1

A fuel injection apparatus according to Embodiment 1 of the present disclosure will be described first.

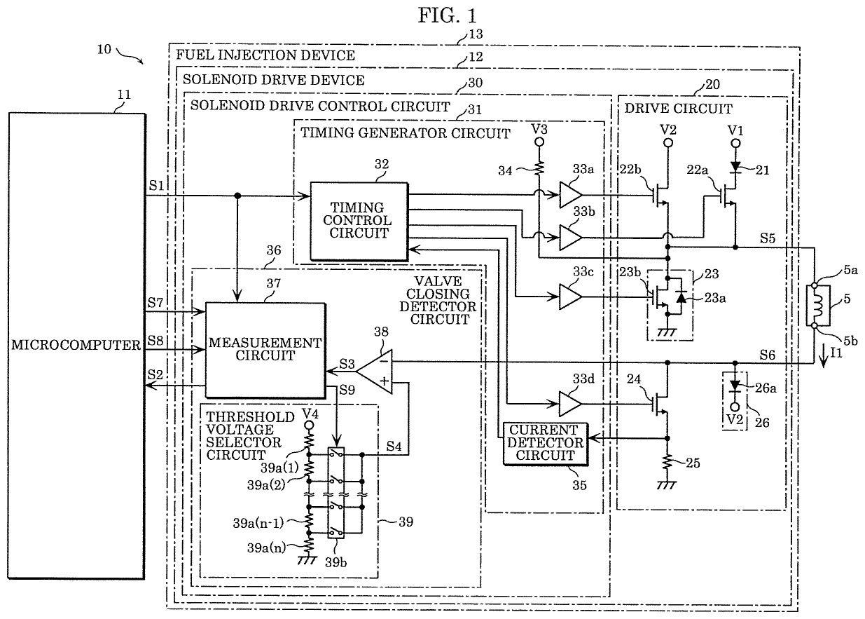

FIG. 1 is a circuit diagram showing a configuration of fuel injection apparatus 13 according to Embodiment 1. Fuel injection apparatus 13 includes solenoid valve 5 for injecting fuel into an engine of transportation equipment and the like, and solenoid valve drive device 12 that performs drive control of solenoid valve 5. A configuration example is shown here of solenoid valve drive device 12 according to the present embodiment being embedded in Engine Control Unit (ECU) 10 including microcomputer 11. Solenoid valve 5 includes inflow terminal 5a into which a current (i.e. coil current) flows and outflow terminal 5b out of which the current flows.

Solenoid valve drive device 12 drives solenoid valve 5, and includes driver circuit 20 and solenoid valve drive control circuit 30. Note that solenoid valve drive device 12 is supplied with fixed voltages (each notated as “voltage V1”, “voltage V2”, “voltage V3”, and “fixed voltage V4”) from respectively battery power supply V1, step-up power supply V2, pull-up power supply V3, and fixed power supply V4. Battery power supply V1 is disposed in a vehicle, and is a battery that supplies voltage V1 (not illustrated in the drawing). Step-up power supply V2 is a power supply that increases voltage V1 supplied by battery power supply V1 to voltage V2. Pull-up power supply V3 is a power supply that supplies voltage V3 via pull-up resistor 34 to inflow terminal 5a of solenoid valve 5. Fixed power supply V4 is a power supply that supplies fixed voltage V4 to divider resistors 39a (1) to 39a (n).

Driver circuit 20 is a circuit that causes the current to flow to solenoid valve 5 in accordance with a timing signal to be received from solenoid valve drive control circuit 30, and includes reverse current protection diode 21, top side switching elements 22a and 22b, top side clamper circuit 23, bottom side switching element 24, detector resistor 25, and bottom side clamper circuit 26.

Reverse current protection diode 21 prevents a reverse current from step-up power supply V2 to battery power supply V1.

Top side switching element 22a is connected between battery power supply V1 and inflow terminal 5a of solenoid valve 5, supplies voltage V1 from battery power supply V1 to inflow terminal 5a of solenoid valve 5, and is, for example, a metal-oxide-semiconductor (MOS) transistor.

Top side switching element 22b is connected between step-up power supply V2 and inflow terminal 5a of solenoid valve 5, supplies voltage V2 from step-up power supply V2 to inflow terminal 5a of solenoid valve 5, and is, for example, a MOS transistor.

Top side clamper circuit 23 is connected between a ground and inflow terminal 5a of solenoid valve 5, causes the current flowing to solenoid valve 5 to flow back, and includes freewheeling diode 23a and switching element 23b connected in parallel. Freewheeling diode 23a is a diode that causes the current flowing to solenoid valve 5 to flow back. Switching element 23b supplies a ground potential to inflow terminal 5a of solenoid valve 5, and is, for example, a MOS transistor. Note that the above ground potential may also be an optional fixed potential.

Bottom side switching element 24 is connected between the ground and outflow terminal 5b of solenoid valve 5, supplies the ground potential to outflow terminal 5b of solenoid valve 5, and is, for example, a MOS transistor.

Detector resistor 25 is connected between bottom side switching element 24 and the ground, and detects the current flowing in solenoid valve 5 (solenoid valve current I1).

Bottom side clamper circuit 26 is connected between outflow terminal 5b of solenoid valve 5 and step-up power supply V2, clamps a voltage of outflow terminal 5b of solenoid valve 5 to at most a fixed value when causing the current flowing to solenoid valve 5 to flow back, and includes freewheeling diode 26a. Note that bottom side clamper circuit 26 is not limited to this configuration and may be a Zener diode connected between outflow terminal 5b of solenoid valve 5 and the ground, and may also be an active clamper circuit including a Zener diode connected to a control terminal of bottom side switching element 24.

Solenoid valve drive control circuit 30 controls driver circuit 20 in accordance with an instruction from microcomputer 11, detects a valve closing timing that is a timing at which solenoid valve 5 closes, and outputs valve closing timing signal S2 to microcomputer 11. Solenoid valve drive control circuit 30 includes timing generator circuit 31 and valve closing detector circuit 36.

Timing generator circuit 31 generates and outputs a timing signal for causing each switching element included in driver circuit 20 to be turned on and off, in accordance with a control signal (solenoid valve opening and closing instruction signal S1) inputted from outside (here, microcomputer 11) for instructing solenoid valve 5 to open and close. Timing generator circuit 31 includes timing control circuit 32, buffer amplifiers 33a to 33d, pull-up resistor 34, and current detector circuit 35.

Timing control circuit 32 is a logic circuit that generates and outputs a timing signal that causes top side switching element 22a, top side switching element 22b, top side clamper circuit 23, and bottom side switching element 24 to be turned on and off based on an output signal from solenoid valve opening and closing instruction signal S1 and current detector circuit 35.

Buffer amplifiers 33a to 33d amplify the timing signal outputted from timing control circuit 32, and output the timing signal to top side switching element 22b, top side switching element 22a, switching element 23b of top side clamper circuit 23, and the control terminal of bottom side switching element 24.

Pull-up resistor 34 supplies voltage V3 from pull-up power supply V3 to inflow terminal 5a of solenoid valve 5.

Current detector circuit 35 is a circuit that detects when the current flowing in solenoid valve 5 (solenoid valve current I1) becomes a predetermined value and, more specifically, a comparator that compares a voltage in detector resistor 25 with a reference voltage corresponding to the predetermined value, and outputs its result to timing control circuit 32.

Valve closing detector circuit 36 detects a valve closing timing after timing generator circuit 31 outputs the timing signal for instructing solenoid valve 5 to close, by monitoring a signal voltage (here, voltage of outflow terminal 5b (solenoid valve outflow terminal voltage S6)) that is determined depending on a voltage in at least one of two terminals included in solenoid valve 5 for causing the current to flow, the valve closing timing being a timing at which solenoid valve 5 closes. Valve closing detector circuit 36 includes measurement circuit 37, comparator 38, and threshold voltage selector circuit 39.

Threshold voltage selector circuit 39 sequentially (e.g. in descending order) selects and outputs threshold voltage S4 from a plurality of threshold voltages in accordance with threshold selection signal S9 inputted from measurement circuit 37. Threshold voltage selector circuit 39 includes divider resistors 39a (1) to 39a (n), and switch circuit 39b. Divider resistors 39a (1) to 39a (n) are resistors for dividing a voltage, are connected between fixed power supply V4 and the ground in series, and each have, for example, the same resistance value. Switch circuit 39b includes a group of switches connected between each connection point and common connection point of divider resistors 39a (1) to 39a (n) that are connected in series, and sequentially outputs a voltage of each connection point by sequentially turning on one switch in the group of switches.

Comparator 38 compares threshold voltage S4 sequentially outputted from threshold voltage selector circuit 39 and inputted to the non-inverting input terminal with the signal voltage (i.e., solenoid valve outflow terminal voltage S6) inputted from the inverting input terminal, and outputs comparator output signal S3 indicating this result to measurement circuit 37.

Measurement circuit 37 (i) detects, based on comparator output signal S3 from comparator 38, each timing of the signal voltage reaching the threshold voltage sequentially outputted from threshold voltage selector circuit 39, and (ii) outputs a signal indicating the valve closing timing (valve closing timing signal S2) when a change in a measurement value that is obtained through measurement of a time interval of each timing satisfies a predetermined condition. To be specific, measurement circuit 37 generates valve closing timing signal S2 based on (i) solenoid valve opening and closing instruction signal S1 and time setting signal S7 inputted from microcomputer 11 and (ii) comparator output signal S3 from comparator 38, and outputs valve closing timing signal S2 to microcomputer 11. Measurement circuit 37 generates threshold selection signal S9 based on (i) threshold switching interval instruction signal S8 inputted from microcomputer 11 and (ii) comparator output signal S3 from comparator 38, and outputs threshold selection signal S9 to threshold voltage selector circuit 39.

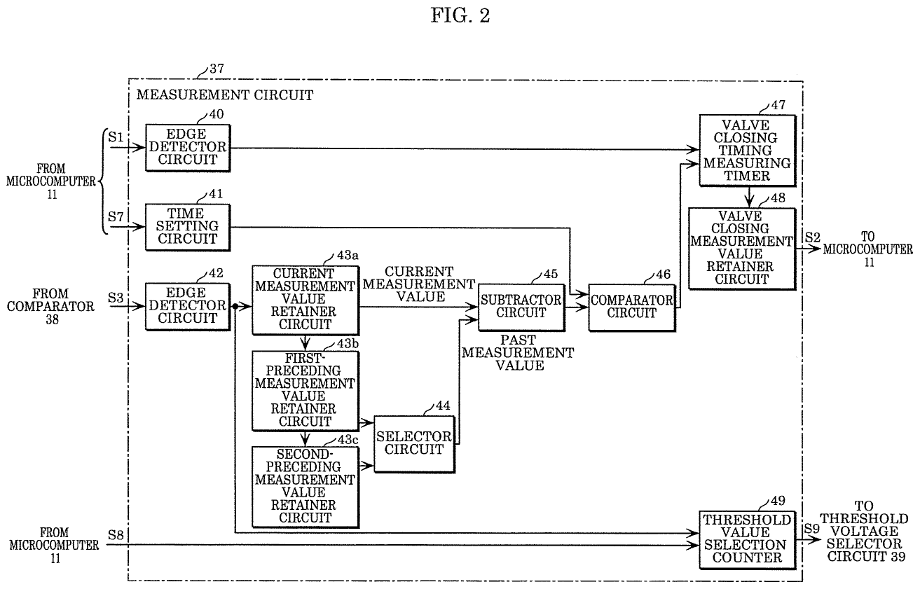

FIG. 2 is a circuit block diagram showing a detailed configuration of measurement circuit 37 shown in FIG. 1. Measurement circuit 37 includes edge detector circuit 40, time setting circuit 41, edge detector circuit 42, current measurement value retainer circuit 43a, first-preceding measurement value retainer circuit 43b, second-preceding measurement value retainer circuit 43c, selector circuit 44, subtractor circuit 45, comparator circuit 46, valve closing timing measuring timer 47, valve closing measurement value retainer circuit 48, and threshold value selection counter 49.

Edge detector circuit 40 detects edges in the closing instruction of solenoid valve opening and closing instruction signal S1 inputted from microcomputer 11, and outputs a signal indicating a timing of the detected edges to valve closing timing measuring timer 47.

Time setting circuit 41 retains a set time indicated by time setting signal S7 inputted from microcomputer 11, and outputs the set time to comparator circuit 46. The set time is used as a threshold value in the comparing performed in comparator circuit 46.

Edge detector circuit 42 detects edges of comparator output signal S3 inputted from comparator 38 (to be specific, the timing at which solenoid valve outflow terminal voltage S6 drops below threshold voltage S4), and outputs a signal indicating a timing of the detected edges.

Current measurement value retainer circuit 43a, first-preceding measurement value retainer circuit 43b, and second-preceding measurement value retainer circuit 43c include a shift register that stores the three most recent successive measurement values.

In other words, current measurement value retainer circuit 43a is a timer that, each time the signal from edge detector circuit 42 is inputted, outputs a previously stored measurement value to first-preceding measurement value retainer circuit 43b along with (i) measuring a time interval from a signal previously inputted from edge detector circuit 42 to a signal currently being inputted from edge detector circuit 42 and (ii) storing the time interval as the current measurement value.

First-preceding measurement value retainer circuit 43b is a latch circuit that, each time the measurement value from current measurement value retainer circuit 43a is inputted, stores the inputted measurement value as a first-preceding measurement value, and outputs the previously stored first-preceding measurement value to second-preceding measurement value retainer circuit 43c.

Second-preceding measurement value retainer circuit 43c is a latch circuit that, each time the measurement value from first-preceding measurement value retainer circuit 43b is inputted, stores the inputted measurement value as a second-preceding measurement value, and discards the previously stored second-preceding measurement value.

Selector circuit 44 selects the greater one of the first-preceding measurement value stored in first-preceding measurement value retainer circuit 43b and the second-preceding measurement value stored in second-preceding measurement value retainer circuit 43c, and outputs it as a past measurement value to subtractor circuit 45.

Subtractor circuit 45 is a subtractor that subtracts the current measurement value stored in current measurement value retainer circuit 43a from the past measurement value selected by selector circuit 44, and outputs the obtained difference (i.e., decrease in the measurement value) to comparator circuit 46.

Comparator circuit 46 is a comparator that (i) determines whether the difference exceeds the set time by comparing the difference outputted from subtractor circuit 45 with the set time indicated by time setting signal S7 stored in time setting circuit 41, and (ii) when the difference exceeds the set time, outputs a signal conveying this to valve closing timing measuring timer 47.

Valve closing timing measuring timer 47 measures the time from when the signal from edge detector circuit 40 is inputted (i.e., when solenoid device opening and closing instruction signal S1 indicates the closing instruction) to when the signal from comparator circuit 46 is inputted, and outputs the measured time to valve closing measurement value retainer circuit 48.

Valve closing measurement value retainer circuit 48 is a latch circuit that stores the time inputted from valve closing timing measuring timer 47, converts this time to valve closing timing signal S2 (e.g. parallel-to-serial conversion), and outputs valve closing timing signal S2 to microcomputer 11.

Through edge detector circuit 40, time setting circuit 41, edge detector circuit 42, current measurement value retainer circuit 43a, first-preceding measurement value retainer circuit 43b, second-preceding measurement value retainer circuit 43c, selector circuit 44, subtractor circuit 45, comparator circuit 46, valve closing timing measuring timer 47, and valve closing measurement value retainer circuit 48, when the difference between the current measurement value obtained through the measurement and the past measurement value obtained at least n (n is an integer of at least 1) measurements ago in measurement circuit 37 is greater than the optionally set time, valve closing timing signal S2 is outputted. At this point, the past measurement value is selected from a plurality of past measurement values obtained through different measurements. To be specific, the past measurement value is a greater one of (i) the first-preceding measurement value obtained one measurement before the measurement of the current measurement value and (ii) the second-preceding measurement value obtained two measurements before the measurement of the current measurement value.

Threshold value selection counter 49 outputs, each time the signal from edge detector circuit 42 is inputted, threshold selection signal S9 that specifies which switch to turn on with respect to switch circuit 39b of threshold voltage selector circuit 39 in accordance with threshold switching interval instruction signal S8 to be inputted from microcomputer 11. For example, when threshold switching interval instruction signal S8 indicates a first state (state indicating a minimum voltage interval), threshold value selection counter 49 outputs threshold selection signal S9 that sequentially causes only one of the switches included in switch circuit 39b to be turned on each time the signal from edge detector circuit 42 is inputted. However, when threshold switching interval instruction signal S8 indicates a second state (state indicating n times the minimum voltage interval), threshold value selection counter 49 outputs threshold selection signal S9 that sequentially causes one of the switches included in switch circuit 39b to be turned on every other n switches each time the signal from edge detector circuit 42 is inputted. This enables threshold voltage selector circuit 39 to change an order of sequentially selecting the threshold voltage from the plurality of threshold voltages, in accordance with threshold selection signal S9 inputted from measurement circuit 37.

An operation of solenoid valve drive device 12 according to Embodiment 1 configured as such will be described next.

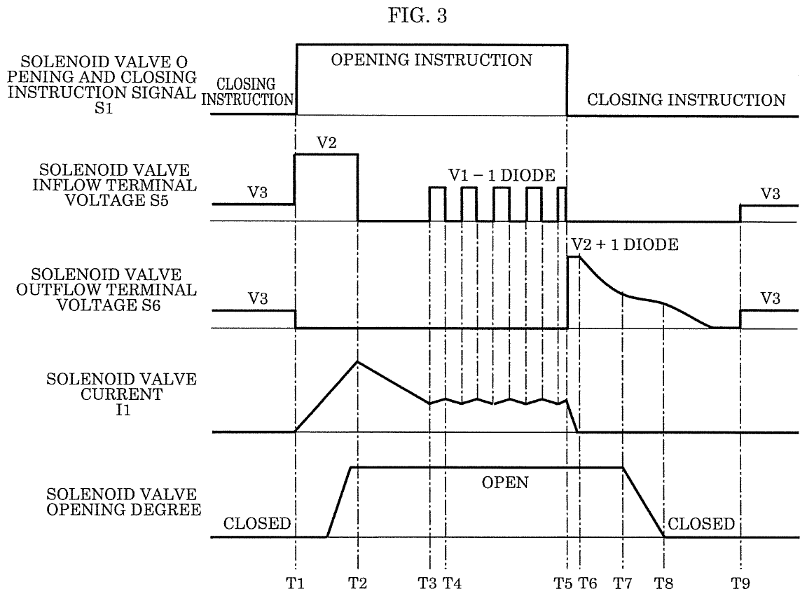

FIG. 3 is a timing diagram showing an operation of solenoid valve drive device 12 according to Embodiment 1. The present drawing shows state changes in “solenoid valve opening and closing instruction signal S1” to be outputted by microcomputer 11, “solenoid valve inflow terminal voltage S5” indicating a voltage in inflow terminal 5a of solenoid valve 5, “solenoid valve outflow terminal voltage S6” indicating a voltage in outflow terminal 5b of solenoid valve 5, “solenoid valve current I1” indicating the current that flows in solenoid valve 5, and “a solenoid valve opening degree” indicating an opening degree of solenoid valve 5.

In an initial state (time until time T1), solenoid valve opening and closing instruction signal S1 is at a low level (closing instruction). At this point, timing generator circuit 31 causes top side switching elements 22a and 22b, switching element 23b, and bottom side switching element 24 to be turned off by outputting the timing signal. As a result, solenoid valve inflow terminal voltage S5 and solenoid valve outflow terminal voltage S6 become voltage V3 of pull-up power supply V3. Since solenoid valve current I1 is not flowing, solenoid valve 5 is in a closed state and fuel is not being injected.

At time T1, solenoid valve opening and closing instruction signal S1 switches from a low level (closing instruction) to a high level (opening instruction). At this point, timing generator circuit 31 causes top side switching element 22b and bottom side switching element 24 to be turned on, and top side switching element 22a and switching element 23b to be turned off by outputting the timing signal. As a result, solenoid valve inflow terminal voltage S5 becomes voltage V2 of step-up power supply V2, and solenoid valve outflow terminal voltage S6 becomes the ground potential. Note that the values of (i) an on resistance of top side switching elements 22a and 22b, switching element 23b, and bottom side switching element 24, and (ii) detector resistor 25 are small enough here to be able to ignore. From time T1, solenoid valve current I1 increases, and concomitantly, solenoid valve 5 starts opening and fuel starts being injected.

At time T2, since current detector circuit 35 detects that solenoid valve current I1 has increased up to the predetermined value, timing generator circuit 31 causes switching element 23b and bottom side switching element 24 to be turned on, and top side switching elements 22a and 22b to be turned off by outputting the timing signal. As a result, solenoid valve inflow terminal voltage S5 and solenoid valve outflow terminal voltage S6 become the ground potential. As such, from time T2, solenoid valve current I1 decreases, but solenoid valve 5 is maintained in an open state and fuel continues being injected.

At time T3, since current detector circuit 35 detects that solenoid valve current I1 has decreased down to the predetermined value, timing generator circuit 31 causes top side switching element 22a and bottom side switching element 24 to be turned on, and top side switching element 22b and switching element 23b to be turned off by outputting the timing signal. As a result, solenoid valve inflow terminal voltage S5 becomes a voltage that has decreased from voltage V1 of battery power supply V1 to reverse current protection diode 21, and solenoid valve outflow terminal voltage S6 becomes the ground potential. As such, from time T3, solenoid valve current I1 increases again, solenoid valve 5 is maintained in an open state, and fuel continues being injected.

At time T4, since current detector circuit 35 detects that solenoid valve current I1 has increased up to the predetermined value, timing generator circuit 31 causes switching element 23b and bottom side switching element 24 to be turned on, and top side switching elements 22a and 22b to be turned off by outputting the timing signal. As a result, solenoid valve inflow terminal voltage S5 and solenoid valve outflow terminal voltage S6 become the ground potential. As such, from time T4, solenoid valve current I1 decreases, but solenoid valve 5 is maintained in an open state and fuel continues being injected.

Hereafter, the operations at time T3 and time T4 are repeated. With this, solenoid valve current I1 continues flowing at or equal to the predetermined value, solenoid valve 5 is maintained in an open state, and fuel continues being injected.

At time T5, solenoid valve opening and closing instruction signal S1 switches from a high level (opening instruction) to a low level (closing instruction). At this point, timing generator circuit 31 causes switching element 23b to be turned on, and top side switching elements 22a and 22b and bottom side switching element 24 to be turned off by outputting the timing signal. As a result, solenoid valve inflow terminal voltage S5 becomes the ground potential, and solenoid valve outflow terminal voltage S6 becomes a voltage that has increased from voltage V2 of step-up power supply V2 to freewheeling diode 26a (“V2+1 diode in FIG. 3”). At this point, a reverse bias voltage “V2+1diode” is applied at either end of solenoid valve 5 and solenoid valve current I1 rapidly decreases. However, solenoid valve 5 is still maintained in an open state and fuel continues being injected.

At time T6, solenoid valve current I1 decreases down to zero. (i) Switching element 23b continues being turned on, (ii) and top side switching elements 22a and 22b, and bottom side switching element 24 continue being turned off. Solenoid valve inflow terminal voltage S5 is maintained as the ground potential, and solenoid valve outflow terminal voltage S6 starts decreasing. Solenoid valve 5 is still maintained in an open state and fuel continues being injected.

At time T7, solenoid valve 5 starts moving from an open state in a closing direction. When solenoid valve 5 moves, a magnetic flux of the coil inside solenoid valve 5 changes, and a reverse voltage occurs in solenoid valve 5 due to the change in magnetic flux. As long as solenoid valve 5 is moving, the magnetic flux continues changing and the reverse voltage continues occurring. The reverse voltage occurs at either end of solenoid valve 5, but since solenoid valve inflow terminal voltage S5 is fixed as the ground potential, the reverse voltage appears in solenoid valve outflow terminal voltage S6. In other words, since the reverse voltage is added to solenoid valve outflow terminal voltage S6 while solenoid valve outflow terminal voltage S6 is in the middle of decreasing, inflection points appear in the change curve of solenoid valve outflow terminal voltage S6 when solenoid valve 5 starts moving (i.e., time T7).

At time T8, solenoid valve 5 closes and fuel stops being injected. When solenoid valve 5 closes, the magnetic flux of the coil in solenoid valve 5 stops changing since solenoid valve 5 stops moving, and the reverse voltage in solenoid valve 5 also stops occurring. Since the reverse voltage does not occur anymore, inflection points appear in the change curve of solenoid valve outflow terminal voltage S6 when solenoid valve 5 stops moving (i.e., time T8).

At time T9, since solenoid valve drive device 12 returns to the initial state, timing generator circuit 31 causes top side switching elements 22a and 22b, switching element 23b, and bottom side switching element 24 to be turned off by outputting the timing signal. As a result, solenoid valve inflow terminal voltage S5 and solenoid valve outflow terminal voltage S6 become voltage V3 of pull-up power supply V3.

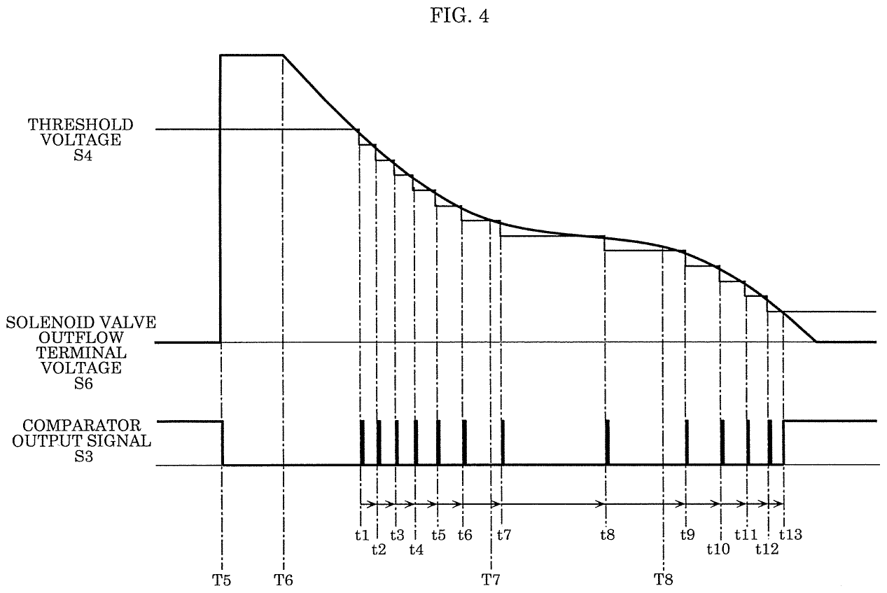

As illustrated by the “solenoid valve opening degree” in FIG. 3, solenoid valve 5 is maintained in an open state and fuel continues being injected from time T5 at which solenoid valve opening and closing instruction signal S1 switches from a high level (opening instruction) to a low level (closing instruction) until time T8 at which solenoid valve 5 closes. As such, it is possible to get close to a desired fuel injection amount by correctly detecting the time from time T5 until time T8 and correcting a control timing of subsequent solenoid valve opening and closing instruction signals S1. Since time T5 that is the timing of the closing instruction is clear to microcomputer 11, it is important to correctly detect time T8 that is the timing at which solenoid valve 5 actually closes (valve closing timing). Valve closing detector circuit 36 is disposed in solenoid valve drive control circuit 30 according to the present embodiment in order to correctly detect time T8 that is the valve closing timing. Hereinafter, an operation of valve closing detector circuit 36 will be described with reference to FIG. 4.

FIG. 4 is a timing diagram showing the operation of valve closing detector circuit 36 according to Embodiment 1. The present drawing shows state changes in “threshold voltage S4” selected by threshold voltage selector circuit 39 and to be inputted to the non-inverting input terminal of comparator 38, “solenoid valve outflow terminal voltage S6” to be inputted to the inverting input terminal of comparator 38 as the signal voltage, and “comparator output signal S3” indicating an output of comparator 38. Time T5 to time T8 in the present drawing correspond to the same times in FIG. 3.

In the initial state (immediately before time T5), solenoid valve outflow terminal voltage S6 is the ground potential. In threshold voltage selector circuit 39, the connection point between divider resistor 39a (1) and divider resistor 39a (2) is selected by switch circuit 39b, and threshold voltage S4 to be outputted from threshold voltage selector circuit 39 to comparator 38 has a maximum value. Since solenoid valve outflow terminal voltage S6 is smaller than threshold voltage S4, comparator output signal S3 is at a high level. Measurement circuit 37 is not operating yet.

At time T5, solenoid valve outflow terminal voltage S6 becomes the voltage that has increased from step-up power supply V2 to freewheeling diode 26a (V2+1diode). Threshold voltage S4 remains at a maximum value. As a result, since solenoid valve outflow terminal voltage S6 is greater than threshold voltage S4, comparator output signal S3 switches to a low level. Measurement circuit 37 is not operating yet.

At time T6, solenoid valve outflow terminal voltage S6 starts decreasing. Threshold voltage S4 has a maximum value and comparator output signal S3 remains at a low level. Measurement circuit 37 is not operating yet. This state continues until time t1.

At time t1, since solenoid valve outflow terminal voltage S6 reaches threshold voltage S4 (drops below threshold voltage S4), comparator output signal S3 switches to a high level. As a result, in measurement circuit 37 that has received comparator output signal S3, comparator output signal S3 is inputted to threshold value selection counter 49 via edge detector circuit 42 and threshold selection signal S9 is outputted from threshold value selection counter 49 to threshold voltage selector circuit 39. With this, the connection point between divider resistor 39a (2) and divider resistor 39a (3) (not illustrated in the drawing) in switch circuit 39b of threshold voltage selector circuit 39 is selected, and threshold voltage S4 that is one step lower than the previous threshold voltage S4 is outputted from threshold voltage selector circuit 39 to comparator 38. As a result, since solenoid valve outflow terminal voltage S6 is greater than threshold voltage S4, comparator output signal S3 switches to a low level again. In measurement circuit 37, a measurement starts of a time interval having time t1 as starting time in current measurement value retainer circuit 43a due to comparator output signal S3 being inputted to current measurement value retainer circuit 43a via edge detector circuit 42 from time t1.

At time t2, since solenoid valve outflow terminal voltage S6 reaches threshold voltage S4, comparator output signal S3 switches to a high level. As a result, in measurement circuit 37 that has received comparator output signal S3, comparator output signal S3 is inputted to threshold value selection counter 49 via edge detector circuit 42 and threshold selection signal S9 is outputted from threshold value selection counter 49 to threshold voltage selector circuit 39. With this, the next connection point, i.e., the connection point between divider resistor 39a (3) (not illustrated in the drawing) and divider resistor 39a (4) (not illustrated in the drawing) in switch circuit 39b of threshold voltage selector circuit 39 is selected, and threshold voltage S4 that is again one step lower than the previous threshold voltage S4 is outputted from threshold voltage selector circuit 39 to comparator 38. As a result, since solenoid valve outflow terminal voltage S6 is greater than threshold voltage S4, comparator output signal S3 switches to a low level again. In measurement circuit 37, a measurement starts of a time interval having time t2 as starting time along with a measurement value corresponding to the time interval from time t1 to time t2 (current measurement value) being retained in current measurement value retainer circuit 43a due to comparator output signal S3 being inputted to current measurement value retainer circuit 43a via edge detector circuit 42.

At time t3, since solenoid valve outflow terminal voltage S6 reaches threshold voltage S4, comparator output signal S3 switches to a high level. As a result, in measurement circuit 37 that has received comparator output signal S3, comparator output signal S3 is inputted to threshold value selection counter 49 via edge detector circuit 42 and threshold selection signal S9 is outputted from threshold value selection counter 49 to threshold voltage selector circuit 39. With this, the next connection point, i.e., the connection point between divider resistor 39a (4) (not illustrated in the drawing) and divider resistor 39a (5) (not illustrated in the drawing) in switch circuit 39b of threshold voltage selector circuit 39 is selected, and threshold voltage S4 that is again one step lower than the previous threshold voltage S4 is outputted from threshold voltage selector circuit 39 to comparator 38. As a result, since solenoid valve outflow terminal voltage S6 is greater than threshold voltage S4, comparator output signal S3 switches to a low level again. In measurement circuit 37, a measurement starts of a time interval having time t3 as starting time along with a measurement value corresponding to the time interval from time t2 to time t3 (current measurement value) being retained in current measurement value retainer circuit 43a due to comparator output signal S3 being inputted to current measurement value retainer circuit 43a via edge detector circuit 42. The measurement value corresponding to the time interval from time t1 to time t2 (first-preceding measurement value) is forwarded from current measurement value retainer circuit 43a to first-preceding measurement value retainer circuit 43b and retained in first-preceding measurement value retainer circuit 43b.

At time t4, since solenoid valve outflow terminal voltage S6 reaches threshold voltage S4, comparator output signal S3 switches to a high level. As a result, in measurement circuit 37 that has received comparator output signal S3, comparator output signal S3 is inputted to threshold value selection counter 49 via edge detector circuit 42 and threshold selection signal S9 is outputted from threshold value selection counter 49 to threshold voltage selector circuit 39. With this, the next connection point, i.e., the connection point between divider resistor 39a (5) (not illustrated in the drawing) and divider resistor 39a (6) (not illustrated in the drawing) in switch circuit 39b of threshold voltage selector circuit 39 is selected, and threshold voltage S4 that is again one step lower than the previous threshold voltage S4 is outputted from threshold voltage selector circuit 39 to comparator 38. As a result, since solenoid valve outflow terminal voltage S6 is greater than threshold voltage S4, comparator output signal S3 switches to a low level again. In measurement circuit 37, a measurement starts of a time interval having time t4 as starting time along with a measurement value corresponding to the time interval from time t3 to time t4 (current measurement value) being retained in current measurement value retainer circuit 43a due to comparator output signal S3 being inputted to current measurement value retainer circuit 44a via edge detector circuit 43. The measurement value corresponding to the time interval from time t2 to time t3 (first-preceding measurement value) is forwarded from current measurement value retainer circuit 43a to first-preceding measurement value retainer circuit 43b and is retained in first-preceding measurement value retainer circuit 43b. The measurement value corresponding to the time interval from time t1 to time t2 (second-preceding measurement value) is forwarded from first-preceding measurement value retainer circuit 43b to second-preceding measurement value retainer circuit 43c and is retained in second-preceding measurement value retainer circuit 43c.

Hereafter, the above operation is repeated in similar fashion. At the timing of time tn, a measurement value corresponding to a time interval from time t(n−1) to time tn (current measurement value) is retained in current measurement value retainer circuit 43a, a measurement value corresponding to a time interval from time t(n−2) to time t(n−1) (first-preceding measurement value) is retained in first-preceding measurement value retainer circuit 43b, and a measurement value corresponding to a time interval from time t(n−3) to time t(n−2) (second-preceding measurement value) is retained in second-preceding measurement value retainer circuit 43c.

A valve closing timing detection process in measurement circuit 37 will be described next.

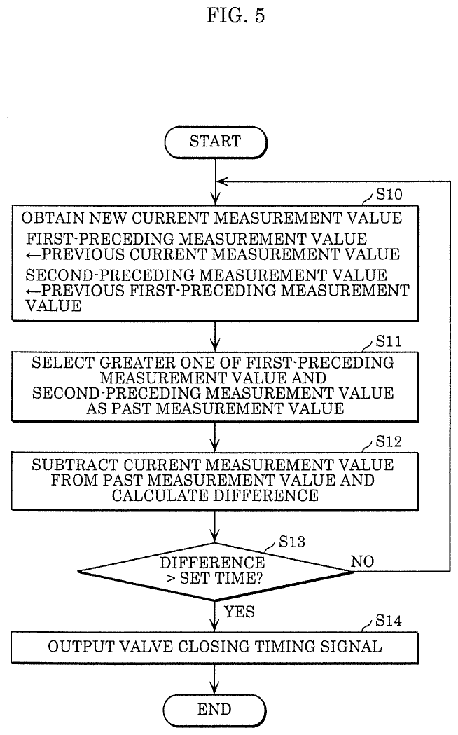

FIG. 5 is a flowchart of the valve closing timing detection process performed by measurement circuit 37 according to Embodiment 1. In measurement circuit 37, the following process is performed each time comparator output signal S3 is inputted, after solenoid valve opening and closing instruction signal S1 indicates the closing instruction.

In other words, as described with reference to FIG. 4, each time comparator output signal S3 is inputted, the three most recent successive measurement values are stored in current measurement value retainer circuit 43a, first-preceding measurement value retainer circuit 43b, and second-preceding measurement value retainer circuit 43c that include the shift register (S10). In other words, the current measurement value is retained in current measurement value retainer circuit 43a, the first-preceding measurement value is retained in first-preceding measurement value retainer circuit 43b, and the second-preceding measurement value is retained in second-preceding measurement value retainer circuit 43c.

Selector circuit 44 selects a greater one of first-preceding measurement value retained in first-preceding measurement value retainer circuit 43b and second-preceding measurement value retained in second-preceding measurement value retainer circuit 43c, and outputs the greater one as the past measurement value to subtractor circuit 45 (S11).

Subtractor circuit 45 subtracts the current measurement value retained in current measurement value retainer circuit 43a from the past measurement value selected by selector circuit 44, and outputs the obtained difference (i.e., decrease in the measurement value) to comparator circuit 46 (S12).

Comparator circuit 46 determines whether the difference exceeds the set time by comparing the difference outputted from subtractor circuit 45 with the set time indicated by time setting signal S7 retained in time setting circuit 41 (813).

As a result, when the difference exceeds the set time, comparator circuit 46 outputs the signal conveying this to valve closing timing measuring timer 47. Valve closing timing measuring timer 47 measures the time from when the signal from edge detector circuit 40 is inputted (i.e., when solenoid device opening and closing instruction signal S1 indicates the closing instruction) to when the signal from comparator circuit 46 is inputted, and outputs the measured time to valve closing measurement value retainer circuit 48. Valve closing measurement value retainer circuit 48 stores the time inputted from valve closing timing measuring timer 47, converts this time to valve closing timing signal S2 (e.g. parallel-to-serial conversion), and outputs valve closing timing signal S2 to microcomputer 11 (S14).

Note that in subsequent timings, threshold voltage S4 to be inputted to comparator 38 drops down to a minimum value due to solenoid valve outflow terminal voltage S6 decreasing. In the end, since solenoid valve outflow terminal voltage S6 is smaller than threshold voltage 84, comparator output signal S3 is fixed at a high level (see time t13) At the timing of time T9 (see FIG. 3) when enough time has passed since the valve closing (time T8), valve closing detector circuit 36 then returns to the initial state (state immediately preceding time T5 in FIG. 3 and FIG. 4) and prepares for the next valve closing detection.

In this manner, in measurement circuit 37, a moment is determined at which the current measurement value has decreased more than the greater one of the first-preceding measurement value and the second-preceding one measurement value (i.e., the past measurement value) for an amount of the set time or longer, and valve closing timing signal S2, which indicates the time from when solenoid valve opening and closing instruction signal S1 indicates the closing instruction up to the valve closing timing, is transmitted from measurement circuit 37 to microcomputer 11.

In the timing diagram of FIG. 4, at the timing when the time interval from time t8 to time t9 is measured as the current measurement value, it is first detected that valve closing timing T8 is present at a measurement time of the current measurement value (from time t8 to time t9), since the current measurement value decreases more than the greater one (here, the first-preceding measurement value) of the first-preceding measurement value (time interval from time t7 to time t8) and the second-preceding one measurement value (time interval from time t6 to time t7) for the amount of the set time or longer. To be specific, the time from T5 to t9 is retained as a valve closing measurement value.

As described above, solenoid valve drive control circuit 30 according to the present embodiment that controls driver circuit 20 including the switching elements that cause the current to flow to solenoid valve 5 includes: timing generator circuit 31 that generates and outputs the timing signal for causing the switching elements included in driver circuit 20 to be turned on and off, in accordance with the control signal inputted from outside for instructing solenoid valve 5 to open and close (i.e., solenoid valve opening and closing instruction signal S1); and valve closing detector circuit 36 that detects the valve closing timing after timing generator circuit 31 outputs the timing signal for instructing solenoid valve 5 to close, by monitoring the signal voltage (in the present embodiment, solenoid valve outflow terminal voltage S6) that is determined depending on the voltage in at least one of the two terminals (in the present embodiment, outflow terminal 5b of solenoid valve 5) included in solenoid valve 5 for causing the current to flow, the valve closing timing being the timing at which solenoid valve 5 closes. Valve closing detector circuit 36 includes: threshold voltage selector circuit 39 that sequentially selects and outputs the threshold voltage from the plurality of threshold voltages; comparator 38 that compares the threshold voltage sequentially outputted from threshold voltage selector circuit 39 with the signal voltage; and measurement circuit 37 that (i) detects, based on the output from comparator 38, each timing of the signal voltage reaching the threshold voltage sequentially outputted from threshold voltage selector circuit 39, and (ii) outputs the signal indicating the valve closing timing when a change in the measurement value that is obtained through measurement of the time interval of each timing satisfies the predetermined condition.

This makes it possible to gradually reduce the coil current of the solenoid valve as in PTL 1 and to shorten the delay time from when the driving period ends to when the solenoid valve closes more than the technique for detecting the valve closing timing using the decrease in the coil current, since the valve closing timing is detected by valve closing detector circuit 36 by monitoring the signal voltage that is determined depending on the voltage in at least one of the two terminals included in solenoid valve 5 for causing the current to flow, the valve closing timing being the timing at which solenoid valve 5 closes.

The valve closing timing is detected using the inflection points appearing in the change curve of the change curve of signal voltage in the valve closing timing and the valve closing timing is detected correctly, since measurement circuit 37 outputs the signal indicating the valve closing timing when a change in the measurement value that is obtained through the measurement of the time interval of each timing of the signal voltage reaching the threshold voltage sequentially outputted from threshold voltage selector circuit 39 satisfies the predetermined condition.

As such, solenoid valve drive control circuit 30 is implemented that is capable of (i) shortening the delay time from when the driving period ends to when solenoid valve 5 closes and (ii) correctly detecting the valve closing timing.

When outputting the timing signal for instructing solenoid valve 5 to close, timing generator circuit 31 outputs the timing signal so that one of the two terminals (in the present embodiment, inflow terminal 5a of solenoid valve 5) becomes the ground potential or the optional fixed potential, the one of the two terminals being included in solenoid valve 5 and for causing the current to flow. Valve closing detector circuit 36 monitors the voltage (in the present embodiment, solenoid valve outflow terminal voltage S6) in the other of the two terminals (in the present embodiment, outflow terminal 5b of solenoid valve 5) as the signal voltage.

With this, the valve closing timing is detected using a simple circuit configuration, since the valve closing timing is detected by only monitoring the voltage in at least one of the two terminals for causing the current to flow and that are included in solenoid valve 5.

The above predetermined condition is the difference between the current measurement value obtained through the measurement and the past measurement value obtained at least n (n is an integer of at least 1) measurements ago being greater than the optional set time.

With this, it is possible to set a margin with respect to fluctuations in the signal voltage due to noise interference and the like and detect the valve closing timing more stably with respect to noise interference and the like more than with the technique for detecting the valve closing timing when the current measurement value is only slightly smaller than the past measurement value as in PTL 1, since the timing of the difference between the current measurement value and the past measurement value being greater than the optional set time is detected as the valve closing timing.

The past measurement value is selected from the plurality of past measurement values obtained through different measurements. For example, the past measurement value is the greater one of (i) the first-preceding measurement value obtained one measurement before the measurement of the current measurement value and (ii) the second-preceding measurement value obtained two measurements before the measurement of the current measurement value.

With this, since a plurality of past measurement values are used as the past measurement value to be compared to the current measurement value, detection errors are limited by stably detecting the valve closing timing with respect to noise interference and the like more than with the technique in PTL 1 that compares the current measurement value with only the previous first-preceding measurement value. When the signal voltage around the inflection points in the change curve of the signal voltage (t6 to t10 in FIG. 4) fluctuates due to noise interference and the like in order to gradually decrease the signal voltage, detection errors easily occur in PTL 1 since the current measurement value is compared with only the previous first-preceding measurement value, but in the embodiment, detection errors are especially reduced since the past measurement value to be compared with the current measurement value is selected from the greater one of the plurality of past measurement values.

Threshold voltage selector circuit 39 changes the order of sequentially selecting the threshold voltage from the plurality of threshold voltages, in accordance with the control signal (threshold switching interval instruction signal S8) inputted from outside for instructing the switching interval of the threshold voltage.

This makes it possible to control a precision of detecting the valve closing timing (i.e. temporal resolution) by controlling a degree of the change (change rate) in the threshold voltage sequentially inputted to comparator 38, since the order of sequentially selecting the threshold voltage from the plurality of threshold voltages is changed in accordance with the control signal inputted from outside for instructing the switching interval of the threshold voltage.

Solenoid valve drive device 12 according to the present embodiment includes driver circuit 20 having the switching elements for causing the current to flow to solenoid valve 5, and solenoid valve drive control circuit 30 that controls driver circuit 20.

With this, a solenoid valve drive device is implemented that is capable of shortening the delay time from when the driving period ends to when the solenoid valve closes and correctly detecting the valve closing timing, similar to solenoid valve drive control circuit 30, since solenoid valve drive device 12 includes solenoid valve drive control circuit 30 having the above characteristics.

Fuel injection apparatus 13 according to the present embodiment includes solenoid valve 5 for injecting fuel into an engine of transportation equipment and the like, and the above solenoid valve drive device 12 that performs drive control of solenoid valve 5.

With this, a fuel injection apparatus is implemented that is capable of shortening the delay time from when the driving period ends to when the solenoid valve closes and correctly detecting the valve closing timing, similar to solenoid valve drive control circuit 30, since solenoid valve drive device 12 includes solenoid valve drive control circuit 30 having the above characteristics.

### Embodiment 2

A fuel injection apparatus according to Embodiment 2 of the present disclosure will be described next.

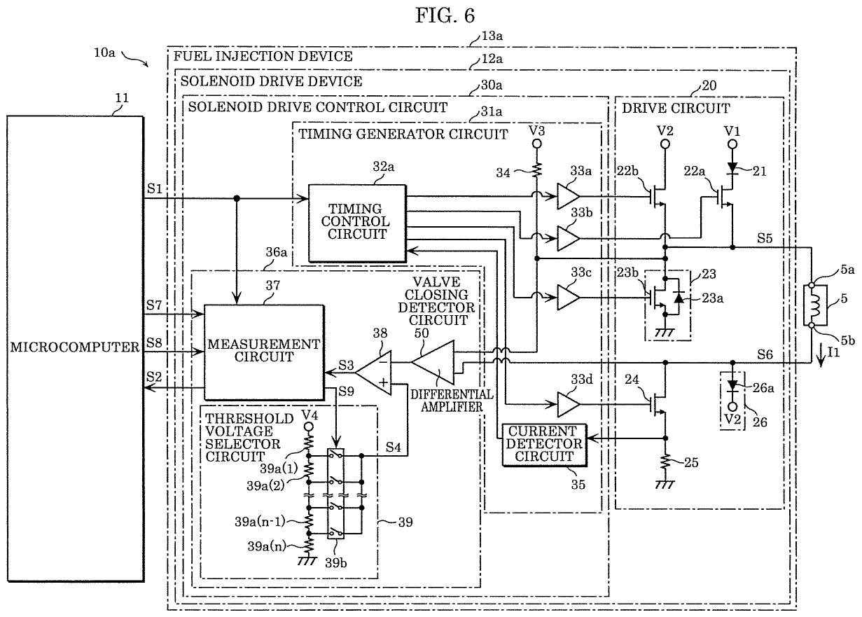

FIG. 6 is a circuit diagram showing a configuration of fuel injection apparatus 13a according to Embodiment 2. Fuel injection apparatus 13a includes solenoid valve 5 for injecting fuel into an engine of transportation equipment and the like, and solenoid valve drive device 12a that performs drive control of solenoid valve 5. A configuration example is shown here of solenoid valve drive device 12a according to the present embodiment being embedded in ECU 10a including microcomputer 11, similar to Embodiment 1.

Solenoid valve drive device 12a drives solenoid valve 5, and includes driver circuit 20 and solenoid valve drive control circuit 30a. Solenoid valve drive control circuit 30a has the same basic functional configuration as Embodiment 1 in that solenoid valve drive control circuit 30a includes timing generator circuit 31a and valve closing detector circuit 36a, but the specific circuit configurations of timing generator circuit 31a and valve closing detector circuit 36a differ from those in Embodiment 1. Hereinafter, differences from Embodiment 1 will mainly be described with components identical to those in Embodiment 1 having the same reference numeral.

In the present embodiment, solenoid valve drive control circuit 30a differs from Embodiment 1, which compares solenoid valve outflow terminal voltage S6 with threshold voltage S4 as the signal voltage, in that solenoid valve drive control circuit 30a detects the valve closing timing by comparing (i) a voltage of a difference between solenoid valve inflow terminal voltage S5 and solenoid valve outflow terminal voltage S6 with (ii) threshold voltage S4 as the signal voltage.

For this reason, valve closing detector circuit 36a includes differential amplifier 50 in addition to the configuration of Embodiment 1. Differential amplifier 50 is an amplifier that calculates the voltage of the difference between solenoid valve inflow terminal voltage S5 and solenoid valve outflow terminal voltage S6, and outputs the voltage of the calculated difference as the signal voltage to the non-inverting input terminal of comparator 38.

Timing control circuit 32a included in timing generator circuit 31a generates the timing signal that causes switching element 23b to be turned off during the closing valve detection operation. As for the generation of other timing signals, timing control circuit 32a is the same as in Embodiment 1.

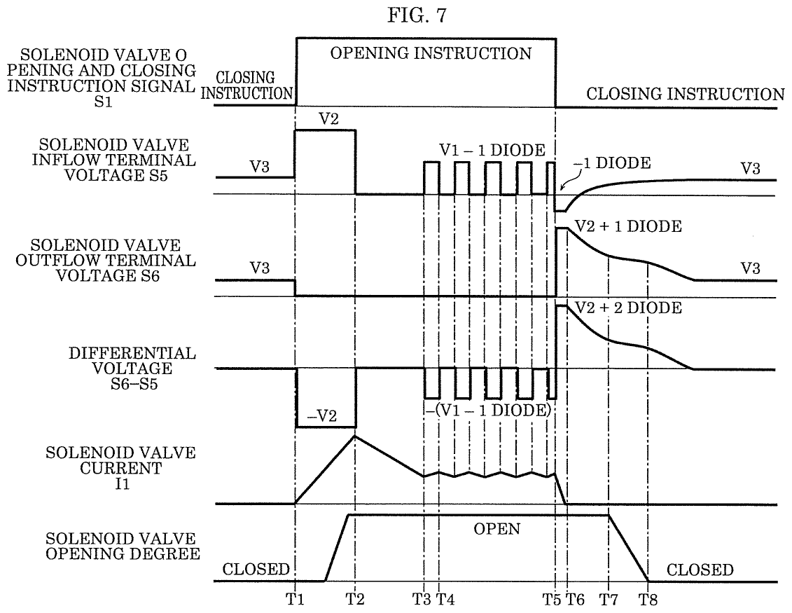

FIG. 7 is a timing diagram showing an operation of solenoid valve drive device 12a according to Embodiment 2 and corresponds to FIG. 3 of Embodiment 1. The present drawing also shows “differential voltage (S6−S5)” that is an output signal of differential amplifier 50 in addition to each signal shown in FIG. 3 of Embodiment 1.

Until time T5, the same operation as in Embodiment 1 is performed in solenoid valve drive device 12a. In comparator 38, however, the output signal of differential amplifier 50 (“differential voltage (S6−S5)”) is compared with threshold voltage S4.

At time T5, solenoid valve opening and closing instruction signal S1 switches from a high level (opening instruction) to a low level (closing instruction). At this point, timing generator circuit 31a causes top side switching elements 22a and 22b, switching element 23b, and bottom side switching element 24 to be turned off by outputting the timing signal.

As a result, solenoid valve inflow terminal voltage S5 becomes a voltage that has decreased from ground potential to freewheeling diode 23a (“−1diode” in FIG. 7), and subsequently (from time T6 onward) gradually increases toward voltage V3 of pull-up power supply V3. However, solenoid valve outflow terminal voltage S6 becomes the voltage that has increased from voltage V2 of step-up power supply V2 to freewheeling diode 26a (“V2+1diode” in FIG. 7), similar to Embodiment 1, and subsequently (from time T6 onward) gradually decreases toward voltage V3 of pull-up power supply V3.

As such, the output of differential amplifier 50 that calculates the voltage of the difference between solenoid valve inflow terminal voltage S5 and solenoid valve outflow terminal voltage S6 becomes voltage “V2+2diode” at time T5 and subsequently (from time T6 onward) decreases gradually down to a zero potential (see “differential voltage (S6−S5)”).

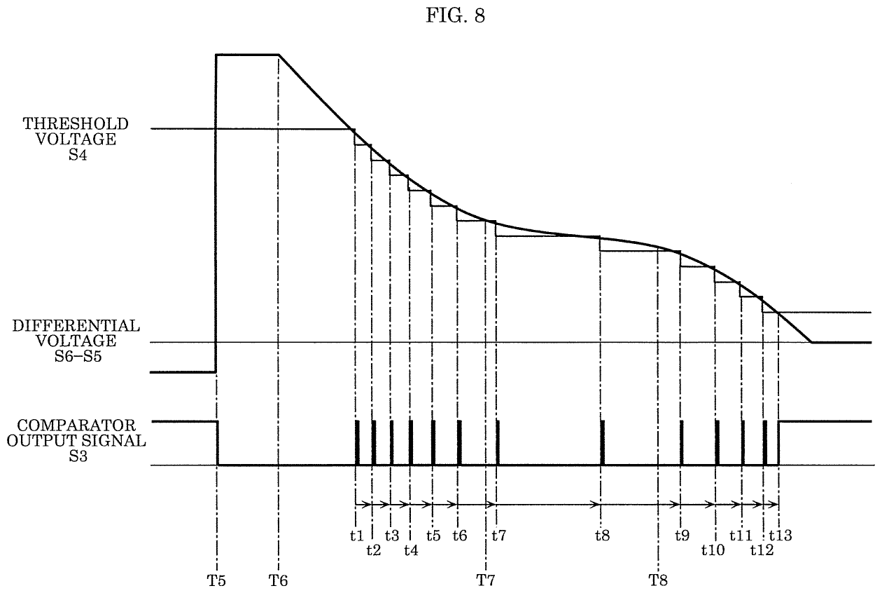

FIG. 8 is a timing diagram showing an operation of valve closing detector circuit 36a according to Embodiment 2 and corresponds to FIG. 4 of Embodiment 1. The present drawing shows “differential voltage (S6−S5)” instead of “solenoid valve outflow terminal voltage S6” in addition to each signal shown in FIG. 4 of Embodiment 1.

In FIG. 8, “differential voltage (S6−S5)” differs from “solenoid valve outflow terminal voltage S6” in FIG. 4 of Embodiment 1 (here, initial value is zero) in that an initial value of “differential voltage (S6−S5)” is negative, but other parts and signals are the same as in FIG. 4 of Embodiment 1.

In other words, in measurement circuit 37, the moment is determined at which the current measurement value has decreased more than the greater one of the first-preceding measurement value and the second-preceding one measurement value (i.e., the past measurement value) for the amount of the set time or longer, and valve closing timing signal S2, which indicates the time from when solenoid valve opening and closing instruction signal S1 indicates the closing instruction up to the valve closing timing, is transmitted from measurement circuit 37 to microcomputer 11.

As described above, in the present embodiment, valve closing detector circuit 36 includes differential amplifier 50 that detects, as the signal voltage, the difference between the voltage in one of the two terminals and the other of the two terminals, the two terminals being included in solenoid valve 5 for causing the current to flow.

With this, since the valve closing timing is detected by comparing the voltage of the difference between either end of solenoid valve 5 with threshold voltage S4 as the signal voltage, the valve closing timing is stably detected with respect to noise interference and the like by securing a high common-mode rejection ratio in a signal transmission from either end of solenoid valve 5 to differential amplifier 50. Especially in vehicles, solenoid valve drive device 12a and solenoid valve 5 are connected by a long cable harness, and noise contamination occurs easily in solenoid valve inflow terminal voltage S5 and solenoid valve outflow terminal voltage S6, but with the present embodiment, the valve closing timing is stably detected by rejecting noise in a common-mode signal.

As such, solenoid valve drive control circuit 30a and solenoid valve drive device 12a according to the present embodiment display the advantageous effect of more stably detecting the valve closing timing in addition to the advantageous effects of Embodiment 1.

The solenoid valve drive control circuit, the solenoid valve drive device, and the fuel injection apparatus have been described above based on Embodiments 1 and 2, but the present disclosure is not limited thereto. Forms obtained by various combinations of the components in Embodiments 1 and 2 that can be conceived by a person skilled in the art which are within the scope of the essence of the present disclosure may also be included in the scope of Embodiments 1 and 2 of the present disclosure.

In the above embodiments, for example, solenoid valve drive control circuit 30 is implemented as hardware by a logic circuit such as a timer, latch, or a comparator, but may also be implemented as software by a microcomputer that includes: ROM containing a computer program, RAM temporarily retaining data, a processor that executes the stored in the ROM, an input-output circuit that communicates with peripheral circuits, etc.

In other words, the present disclosure may be implemented using the following solenoid valve drive control method. This solenoid valve drive control method is a method of controlling driver circuit 20 including the switching elements for causing the current to flow to solenoid valve 5, the method including: a timing generation step of generating and outputting the timing signal for causing the switching elements included in driver circuit 20 to be turned on and off, in accordance with the control signal inputted from outside for instructing solenoid valve 5 to open and close; and a valve closing detection step of detecting the valve closing timing after timing generator circuit 31 outputs the timing signal for instructing solenoid valve 5 to close, by monitoring the signal voltage that is determined depending on the voltage in at least one of the two terminals included in solenoid valve 5 for causing the current to flow, the valve closing timing being the timing at which solenoid valve 5 closes. The valve closing detection step includes: a step of sequentially selecting and outputting the threshold voltage from the plurality of threshold voltages (step performed by threshold voltage selector circuit 39); a step of comparing the threshold voltage sequentially outputted with the signal voltage (step performed by comparator 38); and a step of (i) detecting, based on a comparison result, each timing of the signal voltage reaching the threshold voltage sequentially outputted from threshold voltage selector circuit 39, and (ii) outputting the signal indicating the valve closing timing when a change in the measurement value that is obtained through the measurement of the time interval of each timing satisfies the predetermined condition (step performed by measurement circuit 37).

This solenoid valve drive control method may be implemented as a computer program recorded on a computer-readable recording medium such as CD-ROM or DVD.

In the above embodiments, in measurement circuit 37, the greater one selected from the first-preceding measurement value and the second-preceding measurement value is used as the past measurement value to be compared to the current measurement value, but is not limited thereto. A greater one selected from only n (n is an integer of at least one) first-preceding measurement values, or at least three different n (n is an integer of at least one) first-preceding measurement values may be used as the past measurement value. The past measurement value may be set as any type of measurement value or may be suitably set taking into consideration a desired precision and stability of valve closing timing signal S2.

In the above embodiments, in measurement circuit 37, the set time to be compared to the difference between the past measurement value and the current measurement value is determined through time setting signal S7 to be inputted from microcomputer 11, but is not limited to this method, and may also be a fixed value that is determined in measurement circuit 37.

In the above embodiments, buffer amplifiers 33a to 33d that drive the switching elements included in driver circuit 20 are disposed in solenoid valve drive control circuit 30, but are not limited to such embodiments and may also be disposed in driver circuit 20.

In the above embodiments, the solenoid valve drive control circuit and the solenoid valve drive device applied to the ECU of a vehicle are described, but the solenoid valve drive control circuit and the solenoid valve drive device according to the present disclosure are not limited thereto, and may also be applied to (i) a circuit that controls a solenoid valve for injecting fuel into an engine that is included in another type of apparatus such as an aircraft, and (ii) a control circuit and a drive device of a solenoid valve that require a flow rate of fluid different from the fuel to be injected to be controlled correctly.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure can be used as a solenoid valve drive control circuit, solenoid valve drive device, fuel injection apparatus, and especially a solenoid valve drive control circuit, solenoid valve drive device, and a fuel injection apparatus that are capable of shortening a delay time from when a driving period ends to when a solenoid valve closes and correctly detecting a valve closing timing, e.g., a solenoid valve drive device for injecting fuel into an engine of a vehicle and the like.

What is claimed is:

1. A solenoid valve drive control circuit that controls a driver circuit including a switching element that causes a current to flow to a solenoid valve, the solenoid valve drive control circuit comprising:
a timing generator circuit that generates and outputs a timing signal for causing the switching element to be turned on and off, in accordance with a control signal inputted from outside for instructing the solenoid valve to open and close; and
a valve closing detector circuit that detects a valve closing timing after the timing generator circuit outputs the timing signal for instructing the solenoid valve to close, by monitoring a signal voltage that is determined depending on a voltage in at least one of two terminals included in the solenoid valve for causing the current to flow, the valve closing timing being a timing at which the solenoid valve closes, wherein
the valve closing detector circuit includes:
a threshold voltage selector circuit that sequentially selects and outputs a threshold voltage from a plurality of threshold voltages;
a comparator that compares the threshold voltage sequentially outputted from the threshold voltage selector circuit with the signal voltage; and
a measurement circuit that (i) detects, based on an output from the comparator, each timing of the signal voltage reaching the threshold voltage sequentially outputted from the threshold voltage selector circuit, and (ii) outputs a signal indicating the valve closing timing when a change in a measurement value that is obtained through measurement of a time interval of each timing satisfies a predetermined condition.

2. The solenoid valve drive control circuit according to claim 1, wherein
when outputting the timing signal for instructing the solenoid valve to close, the timing generator circuit outputs the timing signal so that one of the two terminals becomes a ground potential or an optional fixed potential, and
the valve closing detector circuit monitors a voltage in an other of the two terminals as the signal voltage.

3. The solenoid valve drive control circuit according to claim 1, wherein
the valve closing detector circuit further includes a differential amplifier that detects, as the signal voltage, a difference between a voltage in one of the two terminals and a voltage in an other of the two terminals.

4. The solenoid valve drive control circuit according to claim 1, wherein
the predetermined condition is a difference between a current measurement value obtained through the measurement and a past measurement value obtained at least n measurements ago being greater than an optional set time, where n is an integer of at least 1.

5. The solenoid valve drive control circuit according to claim 4, wherein
the past measurement value is selected from a plurality of past measurement values obtained through different measurements.

6. The solenoid valve drive control circuit according to claim 5, wherein
the past measurement value is a greater one of (i) a first-preceding measurement value obtained one measurement before the measurement of the current measurement value and (ii) a second-preceding measurement value obtained two measurements before the measurement of the current measurement value.

7. The solenoid valve drive control circuit according to claim 1, wherein
the threshold voltage selector circuit changes an order of sequentially selecting the threshold voltage from the plurality of threshold voltages, in accordance with a control signal inputted from outside for instructing a switching interval of the threshold voltage.

8. A solenoid valve drive device, comprising:
a driver circuit including a switching element that causes a current to flow to a solenoid valve; and
the solenoid valve drive control circuit according to claim 1 that controls the driver circuit.

9. A fuel injection apparatus, comprising:
a solenoid valve for injecting fuel into an engine of transportation equipment; and
the solenoid valve drive device according to claim 8 that performs drive control of the solenoid valve.
